(19) United States
(12) Patent Application Publication
(10) Pub. No.: US 2026/0359464 A1
(43) Pub. Date: Nov. 12, 2026

(54) Real-Time Dynamic Federated Multi-Tenant NLU Architecture for Synchronization Across Applications and Channels

(71) Applicant: Bank of America Corporation, Charlotte, NC (US)

(72) Inventors: Nipun Mahajan, Lawrenceville, NJ (US); Shreya Sadanand Tamhankar, Mumbai (IN); Sushama Shelke, Mumbai (IN); Yogesh Raghuvanshi, Pennington, NJ (US); Amit Mishra, Chennai (IN); S. B. Pravin Kumar, Nagercoil (IN); Sushil Golani, Charlotte, NC (US)

(21) Appl. No.: 19/201,022

(22) Filed: May 7, 2025

(51) Int. Cl. G06F 21/62

(52) U.S. Cl. CPC G06F 21/6218

(57) ABSTRACT

Systems and methods for Natural Language Understanding (NLU) synchronization across multiple channels via a centralized NLU model. The synchronization can be done on-the-fly in real time, ensuring that the multi-tenant NLU architecture remains adaptive, scalable and precise across various channels and their applications, leveraging shared and specific knowledge and resources. The system and method may include a decentralized federated multi-tenant NLU architecture configured to facilitate NLU synchronization across various channels that ensures both generalized learning from a global model and the domain specific tenants.

### BACKGROUND

Aspects of the disclosure generally relate to computer systems and networks wherein separate computer systems or digital data processing systems performing different tasks share data to accomplish an overall goal. In particular, one or more aspects of the disclosure relate to a federated multi-tenant Natural Language Understanding (NLU) architecture having decentralized models trained locally, a central server to aggregate the updates from the decentralized models to refine in a global model. The global model synchronizes refined NLU patterns across the local models and related channels.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a computer-implemented systems and methods for real-time dynamic federated multi-tenant Natural Language Understanding (NLU) synchronization across multiple channels that may include the steps of receiving, at a central server, a plurality of local model updates from a plurality of decentralized tenant-specific NLU models, each tenant-specific NLU model trained locally on channel-specific data associated with a respective communication channel, aggregating, by the central server, the received local model updates, the local model updates comprising model weights, gradients, and channel-specific application-specific intent embeddings, updating, by the central server, a global NLU model based on the aggregated local model updates, transmitting, from the central server, refinement parameters derived from the global NLU model to the decentralized tenant-specific NLU models, and synchronizing the global NLU model with the plurality of decentralized tenant-specific NLU models.

In some examples, each of the tenant-specific NLU models include a dynamic switching controller that may be configured to receive an input query for interpretation, process the input query through a global intent classifier, an application-specific intent classifier, and a meta classifier in parallel, each generating a respective confidence score, comparing the confidence scores against a predefined threshold, selecting one of the global NLU model or a decentralized tenant-specific NLU model based on the highest confidence score exceeding the predefined threshold, and executing a task selected from the group consisting of intent classification, entity recognition, and sentiment analysis using the selected model.

In yet other examples, the local model updates are encrypted prior to transmission to the central server to preserve data privacy. In another example, the central server does not receive raw data from the plurality of decentralized tenant-specific NLU models, and the raw data remains with the plurality of decentralized tenant-specific NLU models. In other examples, the synchronizing of the global NLU model with the plurality of decentralized tenant-specific NLU models may be in real-time. In yet other examples, the global NLU model may be generated using a FedProx algorithm. In still other examples, the central server does not receive raw data from the plurality of decentralized tenant-specific NLU models, and the raw data remains with the plurality of decentralized tenant-specific NLU models. In one example, a confidence score of each classifier may be further adjusted by a contextual relevance score derived from recent conversation history. In yet another example, the dynamic switching controller modifies model selection behavior based on detected user politeness or formality level. In another example, a database associated with each tenant-specific NLU model may be trained using data associated with language nuance factors, and the data associated with language nuance factors may include tone, context, idiomatic and figurative language, ambiguity, pragmatics, register, cultural references, wordplay, intonation and stress, connotation, politeness and indirectness, honorifics, code-switching, ellipsis and inference, combinations of multiple languages and dialects, and/or combinations thereof.

In some examples, the local model updates are encrypted prior to transmission to the central server to preserve data privacy. In one example, model updates between the central server and tenant-specific NLU models are secured using encryption techniques compliant with industry data protection standards. In other examples, the dynamic switching controller modifies model selection behavior based on detected user politeness or formality level. In yet another example, the central server does not receive raw data from the plurality of decentralized tenant-specific NLU models, and the raw data remains with the plurality of decentralized tenant-specific NLU models. In another example, the global NLU model may be customized based upon a need of each of the plurality of decentralized tenant-specific NLU models.

In another aspect, the disclosure is directed to a system for real-time Natural Language Understanding (NLU) synchronization across multiple communication channels, the system may include a plurality of tenant-specific NLU model modules, each hosted on a decentralized computing environment and configured to train a respective local NLU model on channel-specific data and generate local model updates comprising at least one of: model weights, gradients, or channel-specific intent embeddings, a central server comprising a processor and memory storing instructions that, when executed by the processor, cause the server to receive the local model updates from the plurality of tenant-specific NLU model modules, aggregate the local model updates to update a global NLU model that generalizes NLU features across multiple domains and channels, transmit refinement parameters from the global NLU model back to the plurality of tenant-specific NLU model modules to enable model synchronization, and support dynamic switching between the global NLU model and the tenant-specific NLU models based on contextual channel factors, enabling tasks including intent classification, entity recognition, and sentiment analysis.

In some examples, the system is configured to maintain channel-specific data locally within each decentralized computing environment to preserve channel-specific privacy and security constraints, and the system is further configured to onboard new tenant-specific NLU model modules without disrupting existing tenant operations, thereby enabling scalable expansion of NLU coverage across additional communication channels.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative computing environment for real-time dynamic federated multi-tenant Natural Language Understanding (NLU) synchronization across multiple channels in accordance with one or more arrangements discussed herein;

FIG. 2 depicts an illustrative event sequence for real-time dynamic federated multi-tenant Natural Language Understanding (NLU) synchronization across multiple channels in accordance with one or more arrangements discussed herein;

FIG. 3 depicts an example central server responsible for managing the coordination and communication different tenants, aggregating model updates and sending the global model in accordance with one or more arrangements discussed herein;

FIG. 4 depicts components of local models (i.e., tenants) in accordance with one or more arrangements discussed herein.

FIG. 5 depicts components of a local NLU model in accordance with one or more arrangements discussed herein; and

FIG. 6 depicts an illustrative process for a dynamic switching controller in accordance with one or more arrangements discussed herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to Natural Language Understanding (NLU). These and various other arrangements will be discussed more fully below.

Natural Language Understanding (NLU) is a critical subfield of artificial intelligence (AI) that focuses on enabling computers to interpret and respond to human language in a way that mirrors human comprehension. Unlike basic keyword detection or simple pattern matching, NLU systems are designed to understand the meaning, context, and intent behind spoken or written language. This level of understanding allows computing machines to interact with humans more naturally and intuitively, fostering more effective and human-like communication between people and technology.

One of the core capabilities of NLU is understanding meaning, or semantics. This involves analyzing the relationships between words, identifying parts of speech, interpreting sentence structure, and discerning the overall message being conveyed. Rather than treating each word in isolation, conventional NLU systems assess how words function together to express nuanced ideas. This requires sophisticated models that can parse language in real time, recognize idiomatic expressions, and even handle ambiguity—an area where human language is notoriously complex.

Contextual understanding is another fundamental aspect of NLU. Language does not exist in a vacuum, and typical NLU models are trained to consider the broader conversational context to accurately interpret an utterance. This means remembering earlier parts of a conversation, recognizing references to previously mentioned topics, and even adapting responses based on the user's tone or conversational history. This kind of contextual reasoning enables systems to provide more relevant and coherent interactions over time.

NLU also incorporates sentiment analysis, the ability to detect and interpret the emotional undertones present in language. By identifying whether a user is expressing anger, joy, frustration, or concern, for example, systems can respond with greater empathy and appropriateness. This emotional intelligence is essential in applications like customer support, where tone and mood can significantly impact user satisfaction.

Another vital component of NLU is intent recognition. Rather than merely processing what the user says, intent recognition focuses on why the user is saying it. Whether someone is asking a question, making a request, issuing a command, or expressing a preference, NLU systems must identify the goal behind the message. This is especially important for digital and conversational systems that rely on accurately interpreting user intentions to perform actions or provide meaningful responses.

The technology behind NLU is powered by a combination of machine learning (ML), deep learning, and natural language processing (NLP). Machine learning models—especially those based on deep neural networks—are trained on massive datasets to recognize linguistic patterns, develop predictive capabilities, and continually improve their understanding through exposure to new language inputs. Deep learning models such as Long Short-Term Memory (LSTM) networks, transformers, and attention mechanisms are particularly effective in capturing long-range dependencies and contextual nuances in language.

As a specialized area within NLP, NLU focuses specifically on comprehension, while NLP more broadly includes other processes such as speech recognition, language generation, and translation. Before NLU can analyze language, input typically undergoes preprocessing. This involves tasks like tokenization, where text is broken into words or phrases, and normalization, where variations in spelling, punctuation, and casing are standardized. These steps ensure that the language data is clean and consistent, which enhances model accuracy. Parsing, or syntactic analysis, is also often used to examine sentence structure, helping the system understand the grammatical relationships between different components of a sentence.

NLU may be used in a wide range of practical applications. For example, it powers chatbots that conduct realistic, helpful conversations with users in customer service and technical support environments. In virtual assistants like Siri, Alexa, and Google Assistant, etc., NLU allows the system to interpret voice commands, carry out tasks, and engage in dynamic interactions. Search engines may benefit from NLU by better understanding the user's query intent, thereby returning more relevant and accurate results. In machine translation, NLU helps maintain the meaning, tone, and style of a message when converting between languages. Customer service platforms use NLU to automate responses, prioritize urgent inquiries, and personalize interactions based on prior conversations and known user account data. Furthermore, in content analysis, NLU is used to sift through vast amounts of textual data to identify emerging trends, extract insights, gauge customer sentiment, and support data-driven decision-making in fields such as the financial industry, marketing, medicine, journalism, and public policy.

NLU is a transformative technology at the intersection of linguistics, AI, and data science. By enabling machines to understand not just what we say, but what we mean, it opens the door to more natural, responsive, and intelligent systems that can bridge the gap between human communication and digital technology. NLU, however, faces a number of significant limitations that hinder its ability to fully replicate human language comprehension. One of the most fundamental challenges is linguistic ambiguity. Human language is filled with words and phrases that have multiple meanings depending on context, making it difficult for machines to accurately interpret intent. In addition to syntactic and semantic ambiguity, NLU systems often struggle with pragmatics—the realm of implied meaning, sarcasm, irony, and cultural references. Humans instinctively infer context from tone, body language, and shared social knowledge, but machines lack this intuition. Moreover, maintaining long-term context in a conversation is another major hurdle. While some models can reference previous dialogue turns, many fail to preserve coherence across extended interactions, leading to repetitive or irrelevant responses.

Domain specificity is another area where NLU systems fall short. General-purpose models trained on open internet data often underperform when applied in specialized domains such as wellness, law, or finance. Without domain-specific training, they may misinterpret technical terms or fail to grasp the stakes of nuanced queries.

Multilingual and cross-lingual capabilities also present a challenge. While some models are trained to handle multiple languages, performance varies greatly. Low-resource languages, regional dialects, and code-switching scenarios are often poorly supported, limiting accessibility and effectiveness for global users. Compounding these issues is the lack of real-world knowledge in most NLU systems. Although they can recognize language patterns, they do not possess an internal model of physical or causal reality, which hampers their ability to perform commonsense reasoning or understand abstract concepts.

The models underlying NLU—typically large-scale neural networks such as transformers-also bring their own set of problems. One of the core issues is data dependence. These models require massive datasets to function effectively, raising concerns about data quality, representativeness, and privacy. If the data is noisy or biased, the model's outputs will likely reflect those flaws. Deep learning models are also difficult to interpret, often functioning as “black boxes” whose decision-making processes remain opaque even to their developers. This lack of transparency is especially problematic in regulated industries like accounting or finance, where explainability is crucial.

Resource intensity is another barrier to accessibility and sustainability. Training large language models requires vast computational power and energy, contributing to environmental concerns and limiting adoption by smaller organizations. Furthermore, even state-of-the-art models can suffer from overfitting, where they perform well on training data but fail to generalize to new or slightly altered inputs. Their brittleness is further exposed by adversarial examples that are carefully crafted inputs designed to trick the system into producing incorrect or nonsensical responses.

Finally, whenever a new NLU is to be built for an application, using existing NLU for new application becomes challenging due to several issues. The applications might use domain specific vocabulary, have variability in the intents and have different grammar. Apart from these, the entities in one application might not map in the same manner in the other one. The customers might provide the utterance differently. The mappings between the utterances to intent might differ. In an environment consisting of different applications or channels, building separate NLUs for each application has several drawbacks. Maintaining, training and updating each application requires significant computational resources. Models trained independently may be inconsistent in their performance across applications. It becomes difficult to roll out global updates and integrate new features across channels. Sharing domain features or knowledge across channels becomes critical. Consistency in entity and intent across channels is hard to achieve.

Accordingly, the systems and methods disclosed herein proposes a real-time dynamic federated multi-tenant NLU for NLU synchronization across multiple channels. The federated multi-tenant NLU architecture may have decentralized tenants with models which are trained locally on the channel specific data. A central server may aggregate the updates from local models and refine them in the global model. The global model may be enhanced with patterns from the multiple domains that results in the synchronization across channels along with the tenants which hold local channel specific models. The local models may send channels specific parameters to the global model along with the updates (e.g., weights, gradients and channel-specific application-specific intent embeddings, etc.) for improving the performance and more personalization while maintaining generalization across channels. The architecture disclosed herein addresses the channel specific security concerns as the data stays local. The architecture may be scalable and supports onboarding new channels without disrupting existing ones with improved model performance over time. Further, dynamic switching enables the most appropriate model for intent classification, entity recognition, and sentiment analysis resulting in improved efficiency and personalization.

Other novel aspects disclosed herein include overcoming the challenges of NLU synchronization across multiple channels via the centralized NLU global model. The synchronization can be done on-the-fly in real time, ensuring that the multi-tenant NLU architecture remains adaptive, scalable and precise across various channels and its related applications, leveraging shared and specific knowledge and resources. As will be explained further below, the systems and methods disclosed herein include a decentralized multi-tenant NLU architecture which facilitates NLU synchronization across multiple channels that ensures both generalized learning from the global model and domain specific tenants. Models learn on-the-fly to achieve real-time adaptation to changing customer behavior or new intents across applications and channels without downtime. The dynamic switching adapts to real-time needs and supports diverse tenants with minimal manual intervention. This makes the system and methods disclosed herein more robust and scalable. And the dynamic switching also handles contextual understanding, ambiguity resolution, and overlapping intents and uses the individual tenant's fine-tuned model if the query is domain-specific opposed to the use of the global model

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

The various systems and methods disclosed herein may be operative across one or more computing machines or processors, one or more servers, and one or more networks. The functionality may be distributed in any manner, or may be located in a single computing device/platform (e.g., a server, a client computer, etc.). For example, in alternative embodiments, one or more of the computing platforms discussed above may be combined into a single computing platform, and the various functions of each computing platform may be performed by the single computing platform. In such arrangements, any and/or all of the discussed communications disclosed herein between computing platforms and/or servers and/or networks may correspond to data being accessed, moved, modified, updated, and/or otherwise used by the system or computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

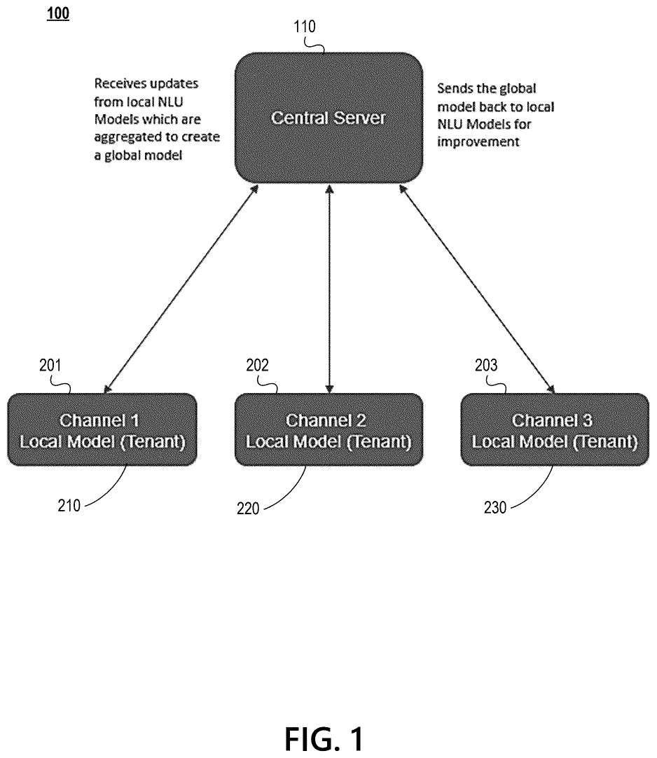

As shown in FIGS. 1-6, the proposed systems and methods disclosed herein introduce a real-time dynamic federated multi-tenant NLU architecture designed to synchronize NLU capabilities across diverse communication channels. At its core, the federated architecture enables decentralized tenants to train local models on their own channel-specific data, enhancing both performance and privacy.

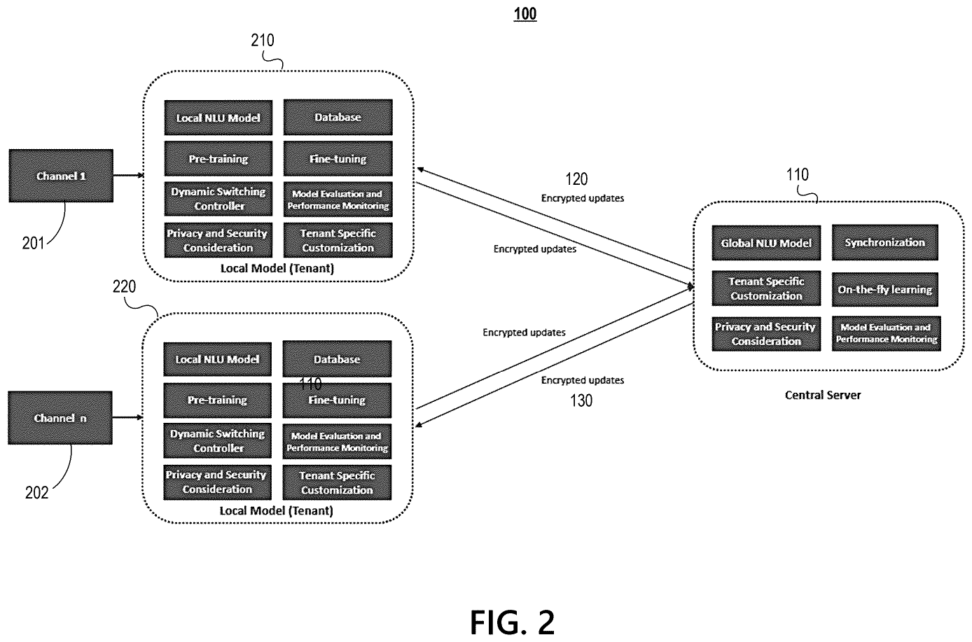

As shown in FIGS. 1 and 2, the system 100 may include a central server 110 and channels 201, 202, 203, . . . etc., that transmit channel-specific parameters from local models 210, 212, 213 . . . etc., such as weights, gradients, application-specific intent embeddings, etc. to the central server 110. The central server 110 aggregates these updates and refines them into a global NLU model enriched with multi-domain patterns. This centralized model and system 100 ensures consistent synchronization and knowledge sharing across local models 210, 220, and 230 while maintaining generalization and enabling personalized responses for each local model 210, 220, and 230.

As shown in FIG. 2, one of the key features of the architecture of system 100 is its strong emphasis on security. Raw data remains local, and only encrypted local model data 120 from local model 210 of channel 201 and local model 220 from channel 202 and the central server 110 as well as model updates 120 and 130 from the central server 210 to channels 201 and 202 to update local models 210 and 220 thereby addressing privacy and regulatory concerns. System 100 and the related architecture may also support scalable onboarding of new tenants without disrupting existing systems and may adapt dynamically to new user behaviors, intents, and channels in real time. A dynamic switching mechanism may intelligently select the most appropriate model, global or tenant-specific, based on the context, complexity, and specificity of user queries. This allows for more accurate intent classification, entity recognition, and sentiment analysis, thereby improving efficiency, personalization, and robustness.

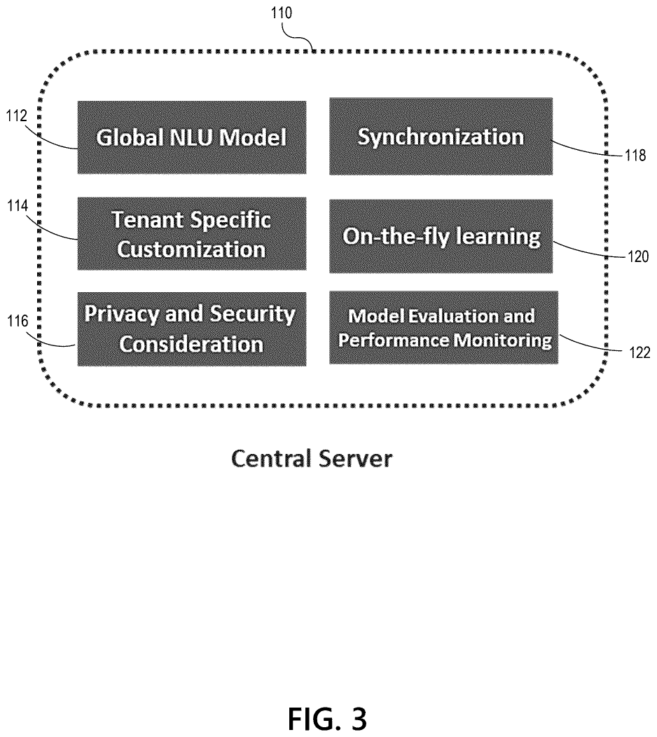

As shown in FIG. 3, the central server 110 plays a pivotal role in orchestrating this federated learning environment. The central server 110 serves as the core intelligence and coordination hub within the federated multi-tenant NLU architecture 100. It performs six primary functions that ensure real-time adaptability, secure data handling, and synchronized performance across all tenant models. At the core of the server is the global NLU model 112, which is constructed by aggregating updates, such as model weights, gradients, and channel-specific intent embeddings, from each tenant's local model. This aggregation produces a robust global model enriched with patterns and behaviors from multiple domains, enabling generalization while retaining tenant-level personalization.

To further support individualized performance, the server incorporates tenant-specific customization module 114, allowing fine-tuning of the global model according to the distinct needs of each tenant. This ensures that domain-specific applications receive tailored intelligence without compromising the integrity of the broader system. In line with stringent privacy protocols, the privacy and security consideration module 116 ensures that the server never accesses or stores raw data. Instead, only encrypted updates are exchanged, allowing data to remain local to each tenant and maintaining compliance with security and regulatory standards.

A key operational component and function of the central server 110 is synchronization module 118 that manages the alignment of local tenant models with the evolving global model. This helps maintain consistency and shared intelligence across all tenants. The server also enables on-the-fly learning via module 120, dynamically integrating new updates in real time without requiring downtime. This functionality is critical for responding to shifts in customer behavior, emerging intents, and evolving language patterns. Finally, the model evaluation and performance monitoring module 122 continuously tracks the performance and convergence of both local and global models. It ensures that the learning process remains efficient, effective, and aligned with system objectives. Collectively, these components allow the central server 110 to support a secure, scalable, and adaptive NLU system capable of serving multiple tenants in real time.

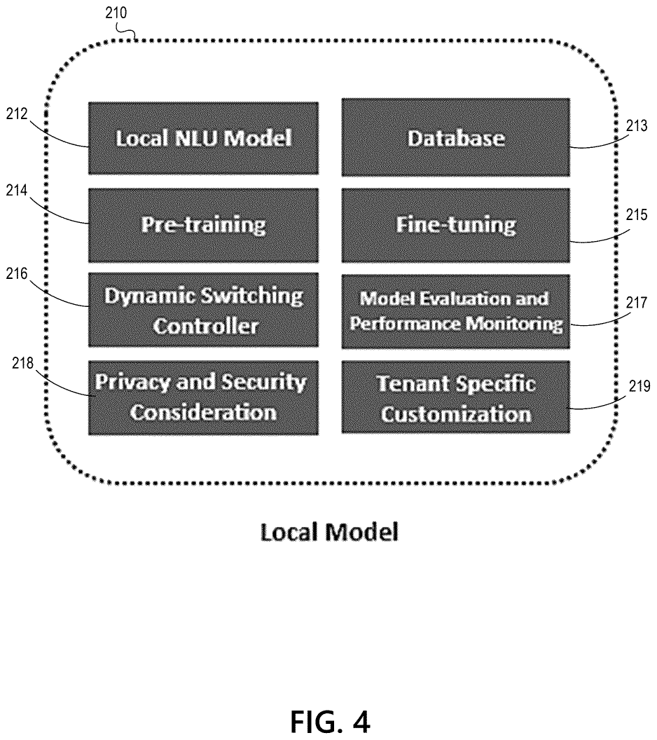

As shown in FIG. 4, each tenant maintains its own local NLU system comprising several integral components. Local model 210, for example, represents the tenant-specific NLU instance that operates independently while contributing to and benefiting from the federated learning architecture. Each local deployment includes several key components that collectively support data collection, model training, personalization, and secure communication with the central server 110. Local NLU model 212 of local model 210 is selected and configured based on the specific application or domain needs of the tenant, such as customer support, financial transactions, e-commerce, etc. Database 213 gathers and stores relevant data from customer interactions, APIs, simulations, or synthetic data generation to support training and adaptation efforts.

Model training within the local environment begins with pre-training module 214, which involves training the NLU model on large-scale general-purpose datasets to establish foundational language and contextual understanding. This is followed by a fine-tuning module 215, in which the model is adapted to the tenant's specific application context, for example, refining the model for intent classification in payment processing or entity recognition in logistics queries. The dynamic switching controller 216 plays a pivotal role in optimizing model performance by determining, in real time, which model (local or global) to deploy based on factors such as query complexity, domain specificity, and system load. This dynamic switching supports intent disambiguation, personalization, and context-aware analysis while balancing efficiency.

To ensure continued effectiveness, each local model includes a model evaluation and performance monitoring 217 module that monitors accuracy, response quality, and adaptation trends. This helps verify whether the local model is learning effectively and aligning with the global model over time. Critical to this architecture is privacy and security consideration module 218 that guarantees that all raw data remains within the tenant's infrastructure. Only processed model updates are encrypted and transmitted to the central server 110, thereby upholding data sovereignty and confidentiality. Finally, tenant-specific customization module 219 facilitates further tailoring of the model to match the tenant's language, domain, and interaction style, ensuring the model remains aligned with real-world usage and evolving business needs. Together, these components enable local model 210 and others to operate autonomously while contributing securely and effectively to the federated NLU system 100. Local models are tailored to specific applications and are trained using customer interactions, APIs, and other domain-specific data. These models may undergo pre-training on large-scale datasets for language and contextual comprehension, followed by fine-tuning for specific applications such as payment intent classification. A dynamic switching controller optimizes model selection based on query complexity, enabling seamless transitions between lightweight models for simple queries and more complex ones for ambiguous or overlapping intents. This ensures effective handling of tasks like intent classification, entity recognition, and sentiment analysis while maximizing efficiency.

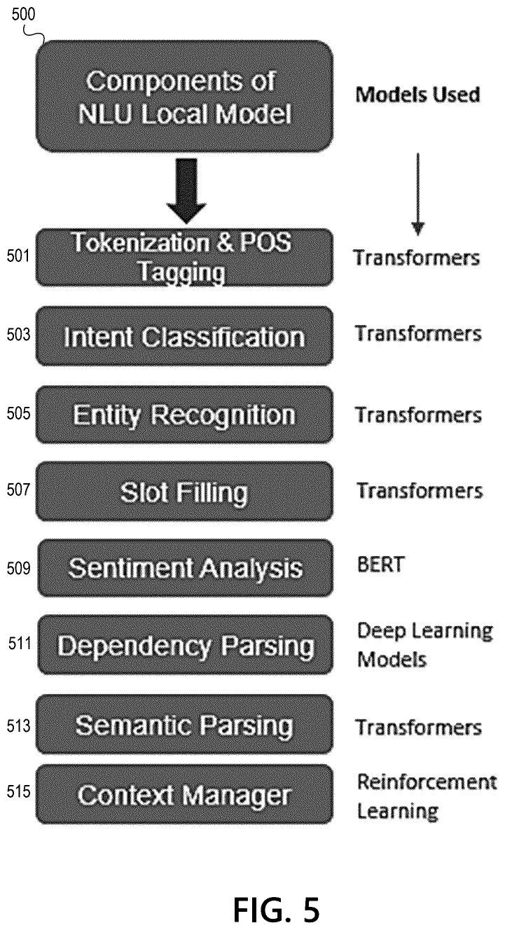

As shown in FIG. 5, NLU local model 500 is composed of a structured pipeline of intelligent components, each designed to progressively interpret and process user input using advanced machine learning methods. The process begins with tokenization and POS Tagging 501, where the input text is segmented into words or subwords, and each token is labeled with its grammatical role (e.g., noun, verb). This foundational task may be performed using transformer-based models, which excel at capturing context and sequence dependencies. Next, intent classification 503 identifies the purpose behind the user's input, such as a request for information or an action, again leveraging transformers for their deep contextual understanding.

Following intent recognition, the system performs entity recognition 505 to detect and categorize key terms in the text, such as names, dates, or product identifiers, using the same class of transformer models. These entities feed into slot filling 507 that extracts structured values from the utterance to populate specific parameters in downstream applications, also relying on transformer architectures. For emotional context, sentiment analysis 509 assesses the tone of the input, determining whether it reflects frustration, satisfaction, or urgency, using models such as BERT, which are fine-tuned for sentiment classification tasks.

Grammatical relationships in the sentence are mapped through dependency parsing 511, which uses deep learning models to build trees of syntactic dependencies, improving the system's ability to interpret complex sentence structures. This is followed by semantic parsing 513, where transformer models are employed to convert natural language input into formal, machine-interpretable meaning representations, such as structured queries or commands. Finally, the context manager 515 uses reinforcement learning techniques to maintain dialogue state, track prior user interactions, conversations, and resolve references across multiple turns of conversation, ensuring coherent and context-aware interactions. Together, these elements enable the system to extract meaning, understand context, and provide intelligent, real-time responses tailored to user needs. Continuous monitoring ensures that both global and local models are converging effectively and performing optimally across all channels, creating a self-improving, secure, and highly adaptive multi-tenant NLU architecture. The models disclosed herein may be trained across a range of nuanced language features that are essential for accurate comprehension and communication. Such features, some previously discussed, may also include each of the following:
Tone—the emotional attitude or disposition conveyed through language, influencing how a message is perceived.
Context—the situational, cultural, or conversational setting in which language is used, shaping the meaning of words and expressions.
Idiomatic and figurative language—phrases whose meanings differ from their literal interpretations, often requiring cultural familiarity to understand.
Ambiguity—arises when a word, phrase, or sentence can have multiple interpretations, necessitating additional cues to determine intent.
Pragmatics—language in use, focusing on how meaning is conveyed beyond literal content, including implied meanings and social conventions.
Register—the level of formality or stylistic tone appropriate to a particular audience or situation.
Cultural references are expressions or allusions—derive meaning from shared societal knowledge, often posing challenges in cross-cultural communication.
Wordplay—involves the creative manipulation of language to produce multiple meanings or humorous effects, which may not translate directly across languages or systems.
Intonation and stress—variations in pitch and emphasis in spoken language that contribute to meaning and emotional expression.
Connotation—the implied or associated meanings of words, which go beyond their dictionary definitions.
Politeness and indirectness—pertain to the use of softened or socially considerate expressions that align with cultural norms and expectations.
Honorifics—structural elements that reflect social roles, hierarchies, or relationships within certain languages.
Code-switching—the practice of alternating between languages or dialects depending on context or audience.
Ellipsis and inference—the omission of information that speakers assume listeners will infer, requiring background knowledge or contextual understanding.
Language combinations—use of multiple languages in the same setting.

In other variations, the models disclosed herein may also be trained with nuanced language features such as language generated from a synthetic source.

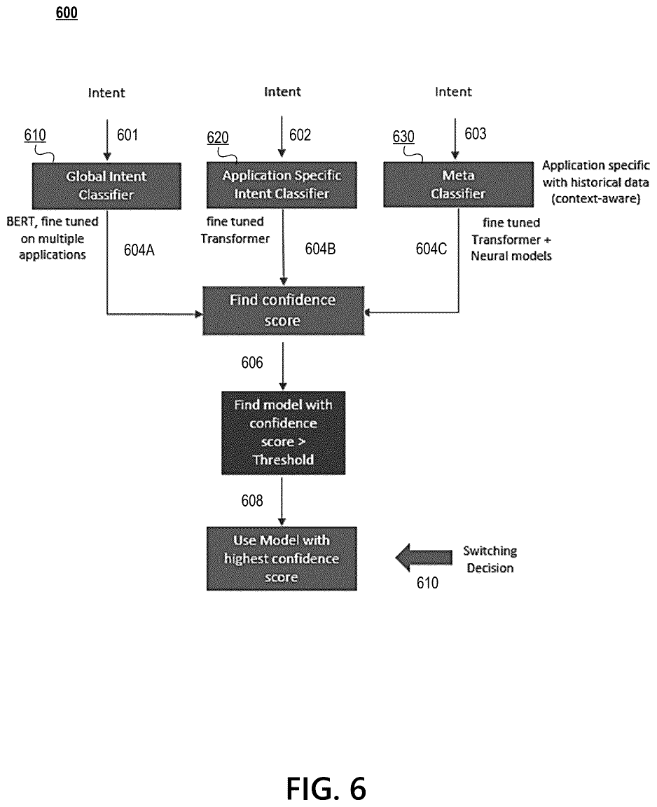

As shown in FIG. 6, the dynamic switching controller 600 is designed to intelligently select the most appropriate NLU model for a given user query by evaluating multiple candidate models in parallel and making a decision based on comparative confidence scores.

At steps 601, 602, and 603, the user intent is simultaneously fed into three distinct classifiers to include the global intent classifier 610, the application-specific intent classifier 620, and the meta classifier 630. The global intent classifier 610 is a generalized model (e.g., BERT-based) trained on a broad set of applications to recognize common intents across domains. The application-specific intent classifier 620 uses a fine-tuned transformer model tailored to the tenant's specific application or service domain. The meta classifier 630 incorporates both transformer and neural models trained with access to historical and contextual data allowing it to offer context-aware predictions based on prior user behavior.

At step 604A, 604B, and 604C, each of these classifiers processes the input intent and produces a corresponding confidence score reflecting the model's certainty in its prediction. These scores are then passed to a comparison module.

At step 606, the system evaluates the collected confidence scores against a predefined threshold. If none of the models exceed the confidence threshold, fallback logic or error handling may be invoked (not shown in the current diagram). Otherwise, the process advances to model selection.

At step 608, the model with the highest confidence score that surpasses the minimum threshold is identified and selected ensuring both accuracy and robustness in prediction.

At step 610, the dynamic switching controller 600 makes a switching decision by selecting and deploying the output from the chosen model, whether global or local, application-specific, or context-aware, for downstream processing such as intent fulfillment, entity extraction, or response generation. This dynamic switching method allows the system to achieve optimal performance across varying domains and user contexts by leveraging the strengths of generalized, specialized, and historical-context models in real time.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

1. A computer-implemented method for real-time dynamic federated multi-tenant Natural Language Understanding (NLU) synchronization across multiple channels, the method comprising:
receiving, at a central server, a plurality of local model updates from a plurality of decentralized tenant-specific NLU models, each tenant-specific NLU model trained locally on channel-specific data associated with a respective communication channel;
aggregating, by the central server, the received local model updates, the local model updates comprising model weights, gradients, and channel-specific application-specific intent embeddings;
updating, by the central server, a global NLU model based on the aggregated local model updates;
transmitting, from the central server, refinement parameters derived from the global NLU model to the decentralized tenant-specific NLU models; and
synchronizing the global NLU model with the plurality of decentralized tenant-specific NLU models, wherein each of the tenant-specific NLU models comprise a dynamic switching controller configured to:
receive an input query for interpretation;
process the input query through a global intent classifier, an application-specific intent classifier, and a meta classifier in parallel, each generating a respective confidence score;
comparing the confidence scores against a predefined threshold;
selecting one of the global NLU model or a decentralized tenant-specific NLU model based on the highest confidence score exceeding the predefined threshold; and
executing a task selected from the group consisting of intent classification, entity recognition, and sentiment analysis using the selected model.

2. The method of claim 1, wherein the local model updates are encrypted prior to transmission to the central server to preserve data privacy.

3. The method of claim 2, wherein the central server does not receive raw data from the plurality of decentralized tenant-specific NLU models, and wherein the raw data remains with the plurality of decentralized tenant-specific NLU models.

4. The method of claim 1, wherein the synchronizing of the global NLU model with the plurality of decentralized tenant-specific NLU models is in real-time.

5. The method of claim 1, wherein the global NLU model is generated using a FedProx algorithm.

6. The method of claim 1, wherein the central server does not receive raw data from the plurality of decentralized tenant-specific NLU models, and wherein the raw data remains with the plurality of decentralized tenant-specific NLU models.

7. The method of claim 1, wherein a confidence score of each classifier is further adjusted by a contextual relevance score derived from recent conversation history.

8. The method of claim 1, wherein the dynamic switching controller modifies model selection behavior based on detected user politeness or formality level.

9. The method of claim 1, wherein a database associated with each tenant-specific NLU model is trained using data associated with language nuance factors, wherein the data associated with language nuance factors comprise a voice generated from a synthetic source.

10. The method of claim 1, wherein a database associated with each tenant-specific NLU model is trained using data associated with language nuance factors, wherein the data associated with language nuance factors comprise context, idiomatic and figurative language, ambiguity, pragmatics, register, cultural references, wordplay, intonation and stress, connotation, politeness and indirectness, honorifics, code-switching, ellipsis and inference, and combinations of multiple languages and dialects.

11. A computer-implemented method for real-time dynamic federated multi-tenant Natural Language Understanding (NLU) synchronization across multiple channels, the method comprising:
receiving, at a central server, a plurality of local model updates from a plurality of decentralized tenant-specific NLU models, each tenant-specific NLU model trained locally on channel-specific data associated with a respective communication channel;
aggregating, by the central server, the received local model updates, the local model updates comprising model weights, gradients, and channel-specific application-specific intent embeddings;
updating, by the central server, a global NLU model based on the aggregated local model updates;
transmitting, from the central server, refinement parameters derived from the global NLU model to the decentralized tenant-specific NLU models; and
synchronizing the global NLU model with the plurality of decentralized tenant-specific NLU models in real-time.

12. The method of claim 11, wherein a database associated with each tenant-specific NLU model is trained using data annotated with language nuance factors, wherein the data associated with language nuance factors comprise tone, context, idiomatic and figurative language, ambiguity, pragmatics, register, cultural references, wordplay, intonation and stress, connotation, politeness and indirectness, honorifics, code-switching, ellipsis and inference, and combinations of multiple languages and dialects.

13. The method of claim 11, wherein a database associated with each tenant-specific NLU model is trained using data annotated with language nuance factors, wherein the data associated with language nuance factors comprise a voice generated from a synthetic source.

13. (canceled)

14. The method of claim 13, wherein model updates between the central server and tenant-specific NLU models are secured using encryption techniques compliant with industry data protection standards.

15. The method of claim 11, wherein each of the plurality of decentralized tenant-specific NLU models comprise a dynamic switching controller configured to:
receive an input query for interpretation;
process the input query through a global intent classifier, an application-specific intent classifier, and a meta classifier in parallel, each generating a respective confidence score;
compare the confidence scores against a predefined threshold;
select one of the global NLU model or a decentralized tenant-specific NLU model based on the highest confidence score exceeding the predefined threshold; and
execute a task selected from the group consisting of intent classification, entity recognition, and sentiment analysis using the selected model.

16. The method of claim 15, wherein a confidence score of each classifier is further adjusted by a contextual relevance score derived from recent conversation history.

17. The method of claim 15, wherein the dynamic switching controller modifies model selection behavior based on detected user politeness or formality level.

18. The method of claim 11, wherein the central server does not receive raw data from the plurality of decentralized tenant-specific NLU models, and wherein the raw data remains with the plurality of decentralized tenant-specific NLU models.

19. The method of claim 11, wherein the global NLU model is customized based upon a need of each of the plurality of decentralized tenant-specific NLU models.

20. A non-transitory machine-readable medium storing instructions for real-time Natural Language Understanding (NLU) synchronization across multiple communication channels in a system that, when executed by one or more processors, cause the one or more processors to perform steps comprising:
receive, at a central server, a plurality of local model updates from a plurality of decentralized tenant-specific NLU models, each tenant-specific NLU model trained locally on channel-specific data associated with a respective communication channel;
aggregate, by the central server, the received local model updates, the local model updates comprising model weights, gradients, and channel-specific application-specific intent embeddings;
update, by the central server, a global NLU model based on the aggregated local model updates;
transmit, from the central server, refinement parameters derived from the global NLU model to the decentralized tenant-specific NLU models; and
synchronize the global NLU model with the plurality of decentralized tenant-specific NLU models in real-time,
wherein a database associated with each tenant-specific NLU model is trained using data annotated with language nuance factors, wherein the data associated with language nuance factors comprise tone, context, idiomatic and figurative language, ambiguity, pragmatics, register, cultural references, wordplay, intonation and stress, connotation, politeness and indirectness, honorifics, code-switching, ellipsis and inference, and combinations of multiple languages and dialects.

21. The method of claim 11, wherein the local model updates are encrypted prior to transmission to the central server to preserve data privacy.
